(19) United States
(12) Patent Application Publication
(10) Pub. No.: US 2020/0016804 A1
(43) Pub. Date: Jan. 16, 2020

(54) METHOD FOR PRODUCING AN ELONGATE COMPONENT USING A CENTERING ELEMENT

(71) Applicant: LEONI KABEL GMBH, Nuernberg (DE)

(72) Inventors: Joerg Wenzel, Roth (DE); Sebastian Goss, Roth (DE)

(21) Appl. No.: 16/471,323

(22) PCT Filed: Dec. 14, 2017
(86) PCT No.: PCT/EP2017/082747

§ 371 Date: Jun. 19, 2019

(30) Foreign Application Priority Data
Dec. 20, 2016 (DE) 10 2016 225 535.5
Mar. 16, 2017 (DE) 10 2017 002 522.3

(51) Int. Cl. B29C 45/14; B29C 48/06; B29C 48/154; B29C 48/285; B29C 48/30; B29C 48/34

(52) U.S. Cl. CPC B29C 45/14065; B29C 45/14016; B29C 45/14549; B29C 48/06; B29L 2031/3462; B29C 48/2883; B29C 48/301; B29C 48/302; B29C 48/34; B29C 48/154

(57) ABSTRACT

The invention aims to increase concentricity compared to conventional centering methods in a 3D extrusion cycle, using a pressure-controlled or floating centering lance. The invention proposes a device (10) for moulding an elongate component (44), comprising: a moulding arrangement (12) with at least one gate point; and a mould insert (22) that can be received in said moulding arrangement (12) and displaced along a displacement axis (V) relative to the gate point (18), said mould insert (22) at least partly delimiting a cavity (28) in which a solidifying moulding compound (21) added via the gate point (18) can be received, and said device (10) additionally comprising a centering element (34) which is configured to receive an elongate component (44) and guide it along a centering axis (Z) into said cavity (28). The device (10) is also accompanied by a method for moulding an elongate component (44).

The invention submitted in the original application focuses on centering using a centering lance. However, this centering lance is positioned statically to the slide carriage (apart from the fixed pneumatic and electrical adjustment options in a longitudinal direction to the cavity). In this prior art the lance is located, depending on the position in the cavity, partly in front of/in/behind the melt front during a cycle—changing multiple times and not defined! This behaviour thus creates areas in which the cable is to be centred by the lance, but the melt front and the lance tip are at a distance from one another and thus the cable can sag or can be pressed in the cavity by the injection pressure acting on one side.

The present disclosure relates to a device and a method for moulding an elongate component. The moulding can be overmoulding or sheathing. The elongate component can be a cable, for example, a core, a stranded bond, comprise at least one conductor and/or at least one wire and generally form an elongate insert part.

Such objects have previously been manufactured chiefly in the context of extrusion processes, in which the elongate component is guided directly through an extrusion nozzle and a sheathing material is deposited thereon.

It has been shown, however, that these solutions can offer little flexibility in respect of the process sequence and the product variants that can be manufactured. The costs and the reliability of the manufacturing process can suffer from this. An object of the present disclosure, therefore, is to avoid such disadvantages and to improve the sheathing of elongate components.

According to the present disclosure, a device is provided for moulding an elongate component. The device can be part of a conventional injection moulding machine or can be connectable to such a machine.

The device comprises a moulding arrangement, comprising at least one gate point. The moulding arrangement can be couplable to the clamping platens of a conventional injection moulding machine. To this end the moulding arrangement can comprise two mould halves in the manner explained below, which can be coupled to a respective clamping platen. The mould halves can be movable towards one another and liftable from one another in a known manner, in order to be able to manufacture objects and remove them from the device.

The gate point can be a fluid-conducting connection area, in particular in the form of a channel, a bore, an opening and/or a hollow space. The gate point can be connectable to the exit area of moulding compound from a normal injection unit of an injection moulding machine and conduct the moulding compound into a cavity explained below. The gate point can also extend through the moulding arrangement and in particular through at least one of the possible mould halves.

The moulding compound can be a plastic material or a plastic material mixture. The moulding compound can be supplied in a substantially liquid form and then solidify to form an object or a component sheath.

The device can generally be based on an injection moulding principle or be configured to carry out an injection moulding process or a process at least similar to injection moulding. In particular, the device can be connectable for this to known injection units or auger arrangements of an injection moulding machine. As explained below, the objects manufactured can be sheathed cables in particular, wherein the moulding compound supplied solidifies into a suitable sheath.

The device further comprises a mould insert, which can be received in the moulding arrangement and displaced along a displacement axis relative to the gate point. The mould insert can interact for this purpose with possible mould halves of the moulding arrangement and can be insertable movably into these, for example. For this the mould insert can interact with guide arrangements, guide strips, sliding surfaces, carriage arrangements, rails or rollers, which can be provided directly in the moulding arrangement, for example. The displacement of the mould insert can be controlled or regulated by an actuator unit. This can comprise a hydraulic or pneumatic cylinder, for example, which can move the mould insert in a predetermined manner. The movement of the mould insert can take place, furthermore, at least partly parallel to a supply of moulding compound via the gate point.

The displacement axis can run substantially in a straight line or linearly. In the case of a moulding arrangement with mould halves that can be moved towards one another and lifted from one another, the displacement axis can run at an angle to the corresponding closing/opening axis of the mould halves, for example at an angle between approx. 44° and approx. 91° or substantially orthogonally to this.

The mould insert can generally be formed in one piece. Furthermore, it can be configured to be open at least in sections in an area facing the gate point, for example, in order to be able to receive moulding compound supplied via the gate point. However, the mould insert can likewise be configured in multiple parts and comprise two mould halves, for example, which when combined can receive a moulding compound supplied and which are separable from one another again to remove a fully moulded object.

The mould insert also at least proportionally delimits a cavity, in which a solidifying moulding compound supplied via the gate point can be received. The cavity can generally define a hollow space for receiving moulding compound, in order to mould a desired object therefrom. The cavity can specifically comprise wall areas, which define the shape of the solidifying moulding compound and thus at least partly also determine the shape of the object manufactured therefrom. In particular, the cavity can fix an outer peripheral area of the moulding compound supplied or of the object manufactured therefrom. The cavity can generally be configured to be substantially elongated and with a constant or varying and in particular with an, at least in sections, rotationally symmetrical cross section. For example, the cavity can comprise an elongated and in particular tube-shaped hollow space. The cavity can accordingly have a longitudinal axis that can run parallel to the displacement and/or centering axis explained below, or can coincide with this.

The mould insert can enclose the cavity at least in sections from at least one, at least two, at least three or even up to four sides. In other words, the mould insert can delimit a cross section of the cavity, at least in sections, up to at least approx. 25%, at least approx. 50%, at least approx. 75% or up to approx. 100%, wherein the portion remaining if applicable can be delimited by corresponding wall areas of the moulding arrangement. It can likewise be provided that the mould insert forms an outer peripheral area of the object to be manufactured (or an inner peripheral area of the cavity) at least proportionally along its entire length.

The mould insert can finally be displaceable relative to the gate point in such a way that a supply of moulding compound to the cavity via the gate point can take place at least over a predetermined proportion of the relative movement. This can include a predetermined movement path or movement distance, but also a predetermined time duration of more than approx. 1 second, more than approx. 2 seconds or more than approx. 3 seconds, for example. The supply of moulding compound can take place here substantially continuously and/or parallel to the displacement.

The device further comprises at least one centering element, which is adapted to receive an elongate component and guide it along a centering axis into the cavity. As mentioned, the elongate component can generally be an insert part and in particular a cable. This can have a longitudinal axis, which can be oriented as a consequence of the centering parallel to the centering axis or which coincides with this. The centering axis can also run parallel to the displacement axis and/or cavity longitudinal axis or coincide with this. In other words, the centering element can be configured to align the elongate component so that it extends substantially concentrically through the cavity and/or along the displacement axis of the mould insert.

The centering element can comprise an area accessible from outside, in order to introduce the elongate component, and a first end area, which faces the cavity or opens directly into this. The component can thus be led from outside through the centering element into the cavity with a desired orientation.

The centering element and the gate point can also be configured substantially separate from one another and can be aligned relative to one another in a desired manner. Compared with the previously known extrusion processes, this can represent an additional degree of freedom to design the manufacturing process in a desired manner.

The centering element can support the component or contact it directly. For this the centering element can surround the component, at least in sections, or, in other words, receive and guide it in a hollow section. Furthermore, the centering element can extend along the component, at least in sections, in order to interact with this, for example along a length of at least approx. 5 cm, at least approx. 10 cm, at least approx. 20 cm, at least approx. 30 cm or at least approx. 50 cm. The section of the component that interacts with the centering element and is received therein if applicable can be a section that is not to be moulded in the further process and is removed, for example, on conclusion of the moulding process.

It can generally be provided that the component is substantially immobile relative to the centering element during the moulding process. As explained below, the elongate component can also extend substantially through the entire cavity, in particular along its entire length, wherein the centering element can form a first starting point of the extension. Furthermore, the mould insert can be displaceable in such a way that a size of the cavity changes and in doing so receives even an increasing length of the component. The mould insert can move along the component for this purpose, so that the latter is received and surrounded by the cavity along an increasing length.

A further development provides that the mould insert is displaceable along the displacement axis in such a way that the cavity is enlarged. The displacement can be accompanied in particular by a lengthening of the cavity along the displacement axis or the cavity longitudinal axis. For example, the mould insert can delimit a front end of the cavity when seen in a displacement direction and can be displaceable so that this front end moves increasingly away from the gate point, so that the cavity is lengthened.

Following the completed manufacture and possible removal of the object, a displacement of the mould insert in an opposite direction along the displacement axis can naturally also take place, so that it again assumes its original starting position. In this case the cavity can be reduced to its original size again.

During the object manufacture and displacement for cavity enlargement, a coordination of mould insert displacement and moulding compound supply can take place in such a way that the moulding compound supplied flows substantially continuously into the cavity. The mould insert can generally be movable here in such a way that a volume increase in the cavity takes place, at least temporarily, substantially proportionally to the supply of a moulding compound volume. It is understood that this cannot apply to an end phase of the object manufacture, in which to generate a so-called holding pressure, additional moulding compound volume can be supplied once more without the mould insert being displaced further. Likewise, in an initial phase of the object manufacture, the supply of a minimum volume of moulding compound is first awaited before the displacement of the mould insert commences.

The mould insert can be displaceable along the displacement axis so that moulding compound received in the cavity flows from the gate point predominantly in a first direction. This direction can run substantially along the displacement axis and/or correspond to a displacement direction of the mould insert during the supply of moulding compound. Expressed another way, the moulding compound supplied can substantially follow the movement of the mould insert, so that it flows substantially constantly away from the gate point in the first direction or is transported away from the gate point.

References mentioned below to a positioning upstream or downstream of the gate point, for example, may therefore refer to the corresponding flow direction of the moulding compound (and/or the displacement direction of the mould insert). In other words, positioning upstream of the gate point may concern an arrangement outside the flow path of the moulding compound in the first direction, thus in particular a positioning upstream of the gate point when viewed in the displacement direction. Positioning downstream of the gate point, on the other hand, may concern an arrangement inside the flow path of the moulding compound in the first direction, thus in particular a positioning downstream of the gate point when viewed in the displacement direction. In this case even areas through which no moulding compound flow takes place in normal operation, but which are arranged accordingly relative to and in particular upstream of the gate point and the moulding compound flow starting out from this, can be comprised by an upstream positioning.

On the other hand, the moulding compound supplied can even flow contrary to the first direction, at least over a limited length, wherein the volume flowing in the first direction can clearly outweigh this portion, however. For example, following completed manufacturing, the moulding compound volume that flowed in the first direction can apply to more than approx. 80%, more than approx. 90% or more than approx. 95% of the overall volume of the moulding compound supplied. The flowing of a small portion of the moulding compound supplied contrary to the first (main flow) direction can be adjusted system-immanently, as it were, by means of the injection pressure.

According to a further development, the centering element protrudes into the cavity and/or is connected to this in a fluid-conducting manner. In particular, the centering element can be connected directly to the cavity and guide the elongate component directly into this and centre it in the desired manner. Great proximity to or direct abutment on the cavity can improve the reliability of the centering, which is advantageous especially at increased injection pressures. For example, during injection of the moulding compound, the component, which is possibly only dimensionally rigid to a limited extent, can have a flow around it at increased pressure and in several directions, due to which it is pushed out of the centred position actually provided. This can be avoided by positioning the centering element as closely as possible to the gate point.

Furthermore, the centering element can be elongated and/or tubular, or at least comprise a section configured in such a way. The longitudinal axis of the centering element can extend in this case along at least one of centering axis, cavity longitudinal axis, component longitudinal axis and mould insert displacement axis or coincide with this. In the case of a tubular configuration, the component can be pushed into or through the centering element, in order to be guided into the cavity. The centering element can also have a substantially circular and in particular closed cross section in this case.

Finally, the centering element can generally be arranged in a recess section of the cavity or a recess connected to the cavity. Receiving can take place with a predetermined play. For example, an outer diameter of the centering element can be substantially equal to or smaller than an inner diameter of a receiving recess. The recess can be provided in the moulding arrangement and in particular in a possible mould half of this. To make introduction into the recess easier, the centering element can comprise at least one sliding section. This can be arranged as a separate bushing, sleeve or shell on an outer surface of the centering element. The sliding section can likewise comprise a sliding layer and/or sheath on an outer surface of the centering element. The sliding section can generally extend over the entire length of the outer surface of the centering element.

Furthermore, the device can comprise an exit area, from which the elongate component can emerge from the device, in particular wherein the exit area lies substantially opposite the centering element. The exit area can be configured at least proportionally in the mould insert. The component can thus be guided from the centering element to the exit area and extend in this case mostly or completely through the cavity. For this the centering element and the exit area can lie substantially opposite along the cavity longitudinal axis, the mould insert displacement axis and/or the centering axis or be connected by the pertinent axes.

The exit area can comprise an opening, bore, recess or similar, so that the component can emerge into the surroundings. The component can then be guided to a clamping, tensioning or holding device. This can make it possible for the component to be pretensioned, for example by introducing a tensile force within the devices and in particular inside the cavity, in order to maintain its centering. For example, the component can thus be guided substantially concentrically and/or along a longitudinal axis through the cavity.

During the displacement of the mould insert, the mould insert can move on account of the exit area relative to the component, as this slides, so to speak, through the exit area. As explained above, an increasing length of the component can consequently be received in the cavity and moulded by means of the moulding compound.

It can further be provided that the centering element is positioned upstream of the gate point, in particular at a distance of up to approx. 1 cm, up to approx. 2 cm, up to approx. 5 cm or up to approx. 10 cm. The relevant positioning upstream can be the positioning explained above upstream of the gate point in the displacement direction of the mould insert or relative to the moulding compound flow path. The distance data can refer to a distance along the centering axis, the component longitudinal axis, the displacement axis and/or the cavity longitudinal axis.

In other words, the gate point can thus be arranged substantially between the centering element and a front end area of the cavity (and/or of the mould insert) viewed in the displacement direction. As explained below, however, the gate point can also overlap, at least slightly, with the centering element. More importantly the mould insert displacement can also take place so that a main flow direction of the moulding compound (see first direction explained above) is directed away from the centering element.

The device can further comprise a control unit, which is configured to control the supply of moulding compound via the gate point in such a way that a melt front spreading upstream of the gate point does not contact the centering element or only flows around in an area of less than approx. 10 cm, less than approx. 5 cm, less than approx. 2 cm or less than approx. 1 cm in length. The melt front spreading upstream can be a portion of the moulding compound supplied that flows contrary to the first (main flow) direction explained above. This does not substantially follow a displacement movement of the mould insert but can even be opposed to this. The present variant accordingly provides that this portion of the moulding compound supplied does not contact the centering element or only flows around it to a limited extent.

The above length measurements can refer in this case to a length along the centering axis, a longitudinal axis of the centering element or of the component in particular.

A further development provides that the centering element extends, starting out from a position upstream of the gate point, at least as far as the gate point, or by up to approx. 1 cm, up to approx. 2 cm or up to approx. 5 cm beyond. Expressed another way, the centering element can generally lie at least partially opposite the gate point or overlap with this. It can extend here from outside of the cavity and/or moulding arrangement as far as the gate point. According to this variant, the moulding compound to be supplied can thus be injected deliberately onto the centering element. The centering element can act here as a type of annular distributor to distribute the moulding compound supplied uniformly around the component first, whereupon this can flow further downstream into the cavity.

The centering element can also comprise a first end area, which is arranged close to the gate point, and wherein the first end area comprises a flexibly deformable material. More importantly, the centering element can be configured to be dimensionally stable or bend-resistant or can comprise such a material and generally be manufactured from metal, plastic or mixtures thereof. The centering element can likewise be configured in multiple parts and comprise a first dimensionally stable section, for example, and a deformable end area. The provision of a deformable end area can generally be advantageous for variants in which the centering element overlaps with the gate point, so that the moulding compound is injected onto the deformable end area. Furthermore, the first end area can be the end area of the centering element that faces the cavity and/or opens into this.

Alternatively or additionally, the first end area can be manufactured from a material that avoids material adhesions in the injection process, for example PTFE. This can also be provided independently of any possible deformability. Another possibility for avoiding adhesions is preheating of the centering element, in particular if this is manufactured from a metal material.

Independently of or in addition to possible deformability, the first end area can also comprise an interchangeable wear insert, for example a wear insert that is couplable (e.g. by pushing in or on) to a main section of the centering element. The first end area can likewise be generally formed by drawing a hose section and in particular a shrinking hose over a bend-resistant end section of the centering element.

A further development provides that the gate point defines a moulding compound supply direction, which runs at an angle different from 0° to the centering axis, and in particular wherein the moulding compound supply direction runs at an angle between approx. 44° and approx. 91° or substantially orthogonally to the centering axis. In other words, a channel or a bore of the gate point, via which the moulding compound is injected, can run not parallel, but in particular transversely to the centering axis. Furthermore, the gate point and the centering element can be spaced from one another when viewed along the centering axis. As a whole the moulding compound supply and the centering of the component can be substantially decoupled from one another, which is not possible with the previous extruder solutions for cable sheathing.

Finally, it can be provided that the moulding arrangement comprises at least two mould halves, of which one is configured fixedly, and wherein the centering element is coupled to the fixed mould half. The mould halves can be the mould halves already explained that are liftable and lowerable relative to one another, as known from conventional injection moulding machines.

The disclosure also relates to a method, which can be executed in particular by means of a device according to any one of the previous aspects, comprising the steps:
a) guiding of the component into the cavity by means of the centering element;
b) supplying a solidifying moulding compound via the gate point; and
c) moving the mould insert along the displacement axis;
   wherein steps b) and c) are executed at least partly in parallel.

It is understood that the method can comprise further steps to realise any of the aforesaid effects, work steps and/or operating modes of the device. The same applies to the aspects of the exemplary embodiments explained below.

For example, the method can comprise another step of guiding the component from the centering element to an exit area, in order to emerge from the device again, wherein the exit area can be provided in the mould insert. Before executing steps b) and c) the component can be pretensioned, furthermore, for example by applying a tensile force.

The present disclosure is to be explained further by means of figures. These figures show schematically:

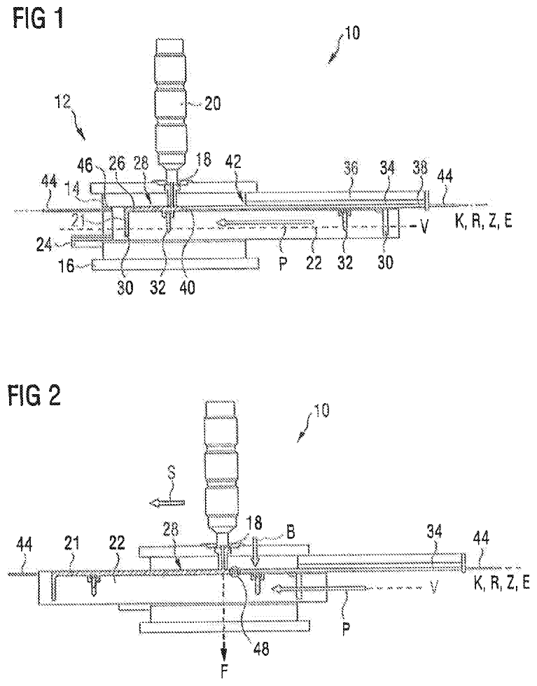

FIG. 1 a view of a device according to a first exemplary embodiment at the beginning of a moulding process;

FIG. 2 the device from FIG. 1 in an advanced stage of the moulding process;

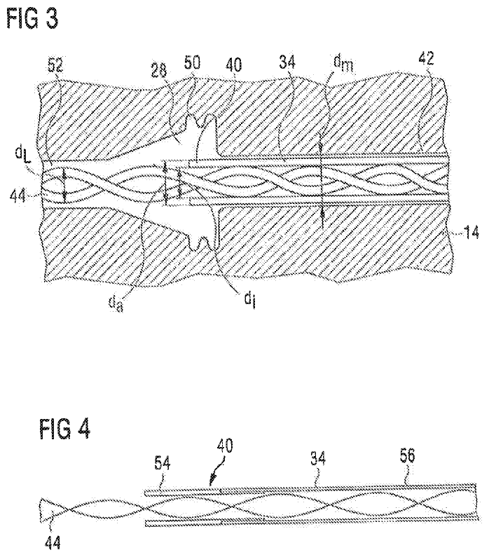

FIG. 3 a detailed view of the centering element of the device from FIG. 1;

FIGS. 4-9 alternative configurations of the centering element;

FIG. 10 a view of another exemplary embodiment, comprising two centering elements;

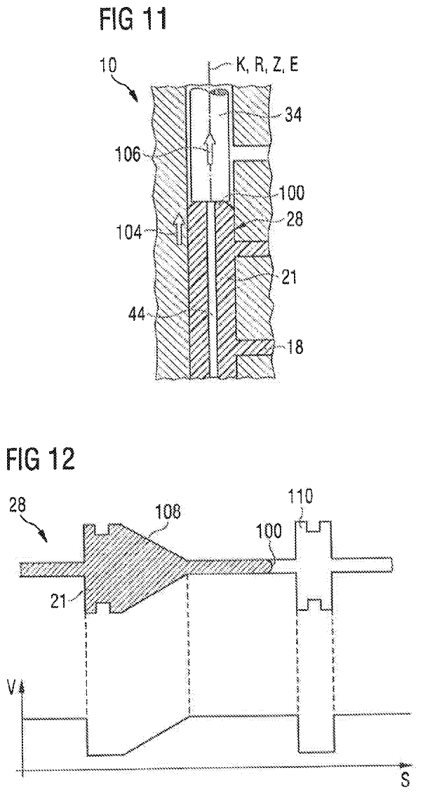

FIG. 11 a schematic diagram of another embodiment for the floating support of the centering lance (also termed illustration 1);

FIG. 12 views for explaining a dependence of the flow behaviour of the melt on the cavity shape (also termed illustration 2);

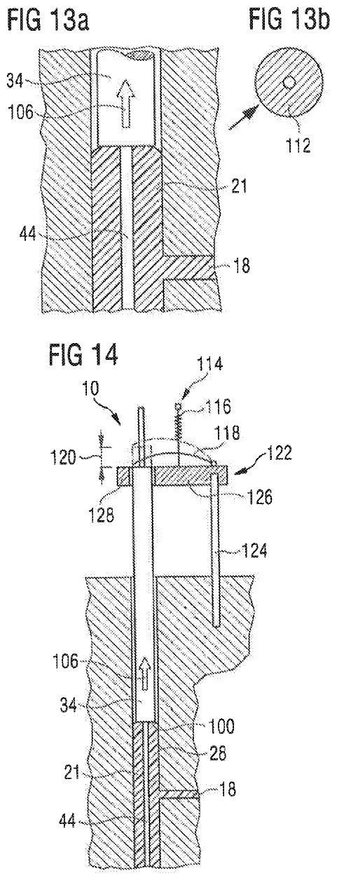

FIGS. 13a, b depictions by analogy with FIG. 10 for explaining the active forces (also termed illustration 3);

FIG. 14 an arrangement for the floating support of the centering lance according to one embodiment (also termed illustration 4);

FIG. 15 a view in perspective (also termed illustration 4B) of the arrangement from FIG. 15; and

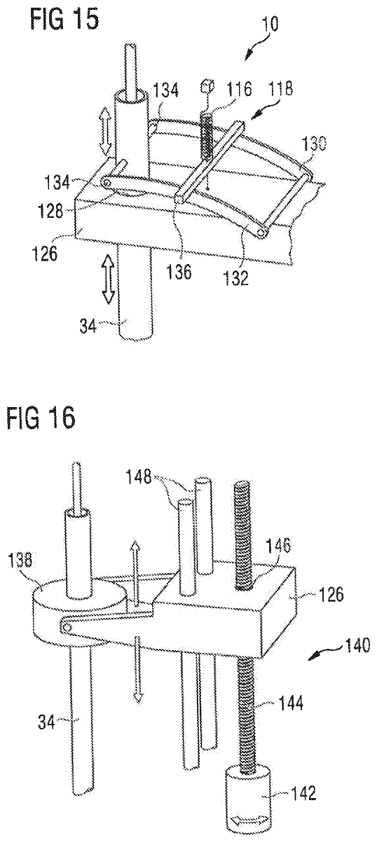

FIG. 16 an arrangement for the floating support of the centering lance according to another embodiment (also termed illustration 5).

In the following, without being restricted to this, specific details are set out to deliver a complete understanding of the present disclosure. However, it is clear to a person skilled in the art that the present disclosure can be used in other exemplary embodiments, which may deviate from the details set out below. For example, specific configurations and arrangements of a device and a method are described below, which should not be regarded as restrictive. Furthermore, different application areas of the device are conceivable. The sheathing of cables or other elongate elements is cited here purely by way of example.

In FIG. 1 a device 10 according to a first exemplary embodiment is shown. The device 10 comprises a moulding arrangement 12. This consists in a known manner of two conventional mould halves 14, 16, which are arranged on clamping platens, not shown, of an injection moulding machine. The upper mould half 14 in FIG. 1 forms a so-called fixed mould half 14, while the lower mould half 16 is movable relative to this in order to achieve a closing and opening movement of the moulding arrangement 12.

The moulding arrangement 12 comprises a gate point 18, which is arranged in the upper mould half 14. The gate point 18 comprises a channel, through which a solidifying moulding compound (in the present case a plastic melt) can be injected into the moulding arrangement 12. The gate point 18 is connected for this purpose to an injection unit 20, which is depicted schematically, of a conventional injection moulding machine.

Also taken up in the moulding arrangement 12 is a mould insert 22. This is shown in FIGS. 1 and 2 in a partial sectional view, so that a cavity portion delimited by this can be recognised. The mould insert 22 is supported movably on guide rails 24 of the lower mould half 16. More precisely, the mould insert 22 is displaceable along a displacement axis V, wherein displacement takes place along the arrow P to manufacture a desired object. In preparation for creating a new object, on the other hand, the mould insert 22 is moved contrary to the arrow P back to a starting position.

The mould insert 22 comprises a recess 26, which is configured substantially oblong. Together with the upper mould half 16 this delimits a cavity 28 of the device 10, in which the moulding compound 21 supplied via the gate point 18 can be received. The cavity 28 is formed in a known manner so that the moulding compound 21 solidifies into an object with desired dimensions and a desired shape. Overall the cavity 28 is configured to be elongated and extends along a longitudinal axis K, which runs parallel to the displacement axis V of the mould insert 22. In the case shown, the cavity 28 additionally comprises two end sections 30, which run substantially transversely to the cavity longitudinal axis K, but only occupy a small proportion of the total volume of the cavity 28. Two screw elements 32 are also shown only by way of example, which are arranged as insert parts in the mould insert 22 and are additionally mouldable into the object to be manufactured.

The device 10 also comprises a centering element 34. This is arranged via a holding arm 36 on the upper mould half 14. The centering element 34 is configured as a thin, elongated metal tube or hollow lance. As is evident from FIG. 1, it accordingly has a longitudinal axis R, which extends parallel to the mould insert displacement axis V and the cavity longitudinal axis K and even coincides with the latter. At its right end 38 in FIG. 1, which end faces away from the moulding arrangement 12 and in particular the gate point 18, the centering element 34 is attached to the holding arm 36. At its left end 40 in FIG. 1, which faces the gate point 18 and the cavity 28 (first end area 40 below), on the other hand, the centering element 34 is received in a channel-like recess 42 in the upper mould half 14.

An elongate component 44 is introduced into the centering element 34. The component 44 is to be sheathed by the moulding compound 21 supplied and can therefore also be termed elongate insert part. It extends through the centering element 34 from the first to the second end area 38, 40. In doing so the component 44 is guided by the centering element into the cavity 28 in such a way that it extends along a centering axis Z. As a result, a longitudinal axis E of the component 44 thus coincides with the centering axis Z, wherein the latter coincides in turn with the cavity longitudinal axis K and the centering element longitudinal axis R as well as running parallel to the displacement axis V of the mould insert 22.

It is also clear from FIG. 1 that the component 44, starting out from the first end area 40 of the centering element 34, enters the cavity 28, extends through the cavity 28 along its longitudinal axis K and emerges from the device 10 again via an exit area 46 without any substantial change in its extension. The exit area 46 is configured here as a bore in the mould insert 22 and lies substantially opposite the centering element 34 when viewed along the centering axis Z. It can generally be provided that the exit area 46 likewise exerts a centering effect on the component 44, for example because it receives and encloses this. However, the exit area 46 can also only provide a passage for the component 44 without any centering effect.

More importantly, the component 44 can also be led by its left-hand end in FIG. 1 to a clamping, holding or pretensioning apparatus, which can exert a pretensioning force on the component 44 to maintain the centering. The component 44 can be connected by its right-hand end in FIG. 1, on the other hand, to a material spool, from which successive predetermined material or component lengths can be unwound. As part of cyclical production, new material sections can be drawn by this prior to each process throughput into the device 10 and in particular into the cavity 28, which sections then form the component 44 to be sheathed. The drawing-in can take place in this case through the centering element 34 without renewed introduction into this being required.

In the case of FIG. 1, the moulding compound 21 supplied is a plastic melt and the component 44 is a metal conductor arrangement, which is to be sheathed by means of the plastic melt. As a result, a sheathed cable is thus manufactured as a finished object.

A sequence of the manufacturing process is explained below as an example by means of FIGS. 1 and 2. In a starting position the component 44 is guided through the centering element 34 and emerges from the device 10 again via the exit area 46. The mould insert 22 is located in a starting position, which is displaced further to the right compared with the position in FIG. 1, so that the left-hand end area 30 lies substantially opposite the gate point 18. In this state the cavity 28 has its smallest volume. In this position, moulding compound 21 is injected under pressure via the gate point 18 into the cavity 28, until the end area 30 is completely filled. A movement of the mould insert 22 then commences in the direction P, wherein the supply of moulding compound is maintained. In this way the mould insert 22 first reaches the position shown in FIG. 1, in order then to be moved continuously further to the left into the position shown in FIG. 2 and even beyond this. The movement is terminated when the right-hand end area 30 lies substantially opposite the gate point 18.

The mould insert 22 is consequently moved in such a way that a length of the cavity 28 increases. In particular, the recess areas 26 of the mould insert 22 arranged to the right of the gate point 18 or upstream of this are not filled initially with moulding compound 21, as these are not connected in a fluid-conducting manner to the gate point 18, or injection pressures that are too great would be required for this. However, in the context of the displacement of the mould insert 22, these recess areas 26 can be moved in the direction of the gate point 18 and thus connected to it to conduct fluid, so that these form actual parts of the cavity 28 and the cavity volume or its length is accordingly enlarged (cf. different cavity volume filled or fillable with moulding compound 21 in FIGS. 1 and 2).

As part of the displacement, the mould insert 22 is moved over the exit area 46 also relative to the fixed component 44. This slides, as it were, through the moving exit area 46. As results from a comparison of FIGS. 1 and 2, this leads in particular to an increasing length of the component 44 being received in the lengthening cavity 28.

The supply of moulding compound 21 takes place, furthermore, in such a way that a flow of moulding compound in the cavity 28 substantially follows a displacement of the mould insert 22 and the increasing cavity 28 is steadily filled with moulding compound 21. The moulding compound 21 is transported in this case along a first (main flow) direction S generally away from the gate point 18 (see FIG. 2). Due to the mobility of the mould insert 22 relative to the component 44, this means that an increasing length of the component 44 is formed and sheathed by the moulding compound 21. Relative to the (main flow) direction S the centering element 34 and in particular its first end area 40 can further be described as positioned upstream of the gate point 18 or as located upstream of the gate point 18 in the displacement direction P. On the other hand, the first end area 30 of the mould insert 22 in FIG. 1 is arranged downstream of the gate point 18, or is located downstream of the gate point 18 in the displacement direction P.

It is also clear from FIG. 2 that the gate point 18 is arranged so that the moulding compound is supplied or injected along a moulding compound supply direction F, which runs substantially transversely to all the aforesaid displacement and longitudinal axes V, K, R, Z, E. The moulding compound 21 thus encounters the component 44 from a substantially orthogonal direction and flows around this along the first (main flow) direction S. On account of the injection pressure a small portion of the moulding compound 21 also flows contrary to the first direction S, however, and in the direction of the centering element 34 (see bordered portion 48 in FIG. 2). However, in FIG. 2 the supply of moulding compound is controlled so that this portion 48 of moulding compound does not reach the centering element 34 and does not flow around it either.

As explained below, such contacting of and flowing around the centering element 34 can also be deliberately intended, however. For this purpose the centering element 34 can be arranged below or overlapping with the gate point 18, so that the moulding compound 21 is injected onto the centering element 34, so to speak.

When the right-hand end area 30 in FIG. 1 has reached the gate point 18 and is filled with moulding compound 21, the forming process is complete. The supply of moulding compound can then be interrupted and the mould halves 14, 16 can be lifted from one another. The manufactured object of solidified moulding compound 21 and sheathed component 44 can then be removed from the mould insert 22. Additional length sections of the component 44, which were not formed, can then be removed and/or used to tail another length section of the component 44, as it were, and starting out from the first end area 40 to guide the centering element 34 through the cavity 28 to the exit area 46. Starting out from a starting position of the mould insert 22, the manufacturing process can then be carried out afresh to produce another sheathed cable.

FIG. 3 shows a schematic detailed view of the first end area 40 of the centering element 34. The visual axis corresponds here to the arrow B from FIG. 2, wherein the upper mould half 14 is depicted as a hatched area. It is again recognised that the centering element 34 is formed as a thin-walled tube, which has an inner diameter dᵢ and an outer diameter dₐ. Also recognised is the recess 42, in which the centering element 34 is received. This has an inner diameter dₘ, which exceeds the outer diameter dₐ of the centering element 34, so that the latter is received in the recess 42 with a certain play. Furthermore, the component 44 is recognised, which comprises a wound conductor arrangement. This has an outer diameter d_{L}, which substantially corresponds to the inner diameter dᵢ of the centering element 34.

It is clear from FIG. 3 that the centering element 34 extends as far as the cavity 28 and thus guides the component 44 with a desired centering directly into the cavity 28. In the example shown, the cavity 28 comprises a conical socket section 50 and an elongated cylindrical section 52.

Another variant of the centering element 34 is shown in FIG. 4. This comprises an interchangeable wear insert 54 in the region of the first end area 40. This is manufactured from a plastic material and inserted into a main section of the centering element 34, which is formed by a metal tube 56. The wear insert 54 can thus be exchanged after a predetermined number of manufacturing processes and/or at the onset of wear, whereas the metal tube 56 can be used over a larger number of manufacturing processes.

Another variant of the centering element 34 is shown in FIG. 5. This comprises a flexibly deformable material, for example PTFE, in the region of the first end area 40. The centering element 34 is otherwise configured once again in the form of a metal tube 56. To provide the flexible deformability, a shrinking hose 59 of the corresponding material is pushed onto the metal tube 56 and fixed thereon in a known manner by heating. A protruding end 57 (below: deformable end area 57) of the deformable material experiences substantially no structural support by the metal tube 56, as it does not overlap with this.

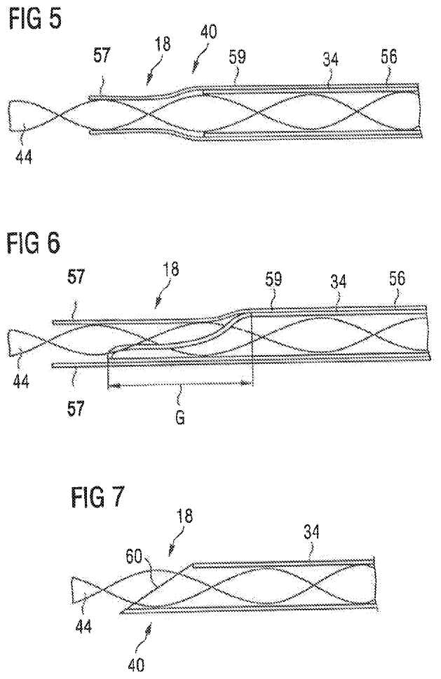

FIG. 6 shows an alternative configuration of the variant in FIG. 5, in which the metal tube 56 is formed in a lower area with an extended circumferential section 58. Viewed in the longitudinal section shown, the metal tube 56 is thus configured substantially in the shape of a spoon. The extended circumferential section 58 thus supports the deformable end area 57 of the flexibly deformable material in a selected region G.

The variants of FIGS. 5 and 6 are particularly interesting if moulding compound 21 is to be injected via the gate point 18 directly onto the centering element 34, wherein the latter acts as a type of annular distributor. A position of the gate point 18 is indicated by way of example in FIGS. 5 and 6. In FIG. 6 in particular, it is recognised that the extended circumferential section 58 is arranged substantially in an area of the metal tube 56 facing away from the gate point 18 and supports the deformable end area 57 locally there.

FIG. 7 shows another variant of the centering element 34. In this case the first end section 40 is configured with a bevelled end, wherein the bevelling is chosen so that an opening 60 of the centering element 34 substantially faces the gate point 18. Another variant, not shown separately, provides the use of the spoon-shaped metal tube 56 from FIG. 6 without an additional deformable material overlay as a centering element 34.

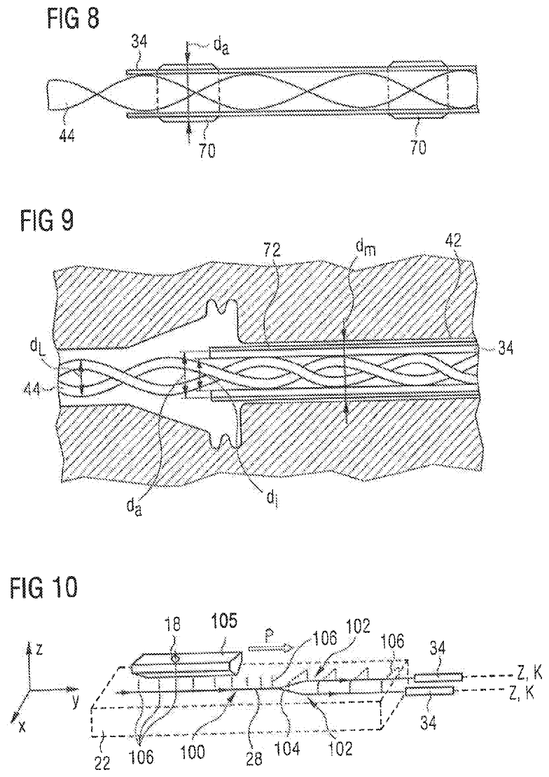

FIGS. 8 and 9 finally show solutions for improving a sliding capacity of the centering element 34. This is relevant in particular for the introduction of the centering element 34 into the recess 42 of the moulding arrangement 12. In the case of FIG. 8, the tubular centering element 34 comprises several slide sleeves 70, which define an outer peripheral area or greatest outer diameter dₐ of the centering element 34. In the case of FIG. 9, the tubular centering element 34 comprises a sliding layer 72 that extends over its entire length, which likewise determines the greatest outer diameter dₐ. The illustration otherwise corresponds to that of FIG. 3. The outer diameters dₐ of the centering element 34 in FIGS. 8 and 9 are each selected so that they substantially correspond to the inner diameter dₘ of the recess 42 from FIG. 9 or lie only slightly below it.

FIG. 10 shows another exemplary embodiment comprising two tubular centering elements 34. The mould insert 22 is indicated by dashed lines in FIG. 10. It comprises two insert mould halves, which are not depicted separately and which together delimit a cavity 28 represented as a line. The cavity 28 comprises a first linear section 100. This extends directly in a mould joint between the insert mould halves of the mould insert 22. Furthermore, the mould joint extends parallel to the X-Y plane according to the coordinate system from FIG. 10.

The cavity 28 further comprises two parallel sections 102. More precisely, the section 100 of the cavity 28 divides at a branching point 104 into two parallel lines 102. If the insert mould halves are lifted from one another, a three-strand or Y-branched conductor arrangement can be inserted into the cavity 28. It is understood that other mould partitions are also conceivable, however, and in particular a plurality of mould parts instead of only two mould halves can be provided.

Also recognised in FIG. 10 is a gate point 18, which is configured in a carriage-like base body 105. This is generally stationary and slides along a guide recess, which is not shown separately, on a surface of the mould insert 22. By analogy with the embodiment from FIG. 1, the base body 105 is formed on an upper fixed mould half (not shown). Lying opposite the base body 105, furthermore, is a lower mould half, which is likewise not depicted, wherein the mould insert 22 is arranged between the two mould halves.

The mould insert 22 is displaced along the direction P relative to the gate point 18. The cavity 28 is connected by a plurality of distribution channels 106 to the guide recess of the mould insert 22, which slides along the gate point 18. For reasons of illustration not all distribution channels in FIG. 10 are provided with a corresponding reference sign. In this displacement of the mould insert 22, the distribution channels 106 are arranged consecutively opposing the gate point 18 or are temporarily aligned with this. A continuous fluid-conducting connection is thus provided between the gate point 18 and the cavity 28, so that the cavity 28 can be supplied substantially continuously with moulding compound during the displacement of the mould insert 22 (see also corresponding moulding compound flows in the cavity 28 indicated by arrows).

FIG. 10 shows a state in which the mould insert 22 was already displaced over a comparatively large distance relative to the gate point 18. In a starting state the mould insert is arranged so that during a displacement along the arrow P, the furthest right, two-strand distribution channel 106 in FIG. 10 initially aligns with the gate point 18. Then a displacement takes place according to the arrow P, wherein the other consecutive distribution channels 106 are arranged one after another opposing the gate point 18.

To centre a conductor arrangement inserted into the cavity 28, the centering elements 34 already mentioned are arranged at the right end in FIG. 10. These are again configured as thin, elongated tubes, which receive a free end of the conductor strands, which are guided in through the parallel sections 102 of the cavity 28. Here the centering elements 34 each define a centering axis Z, which coincides with a cavity longitudinal axis K defined by each of the parallel sections 102.

The free conductor strands, which are guided through the parallel sections 102 of the cavity 28 and protrude from the mould insert 22, can thus be centred by take-up inside the centering elements 34. In this case the mould insert 22 generally moves towards the centering elements 34.

In principle it is also conceivable, however, that the centering elements 34 protrude into the mould insert 22 or are enclosed by this, at least temporarily, so that they extend, at least in sections, inside the cavity 28. It is likewise conceivable to provide a corresponding centering element 34 also at the left-hand end of the cavity 28 in FIG. 10.

Finally, the provision of a plurality of centering elements 34 is not restricted to the particular variant of the mould insert 22 from FIG. 10, which is displaced along a carriage-like base body 105. For example, it is conceivable also in the embodiment according to FIG. 1 to arrange another cavity section and another centering element 34 parallel to the centering element 34 shown (for example, offset into the image plane). The moulding compound injected via the gate point 18 can be diverted here via connecting channels into a corresponding parallel cavity section (see also two-strand distribution channels 106 in right-hand half of the mould insert 22 from FIG. 10). However, a separate gate point 18 can also be provided for the parallel cavity section.

By providing a plurality of centering elements 34 even branched and more complex conductor arrangements can be centred and reliably moulded and sheathed.

### Solution of the Invention According to Other Aspects, Which Relate to the Floating Support of the Centering Element

In the following, aspects are described that are based on the previous aspects and additionally relate to a floating support of the centering element. First a general description is given. Then specific examples are explained by means of FIGS. 11-16.

The core of these other aspects of the invention is to support the centering lance “floating” on the melt front. At least according to certain embodiments, the centering lance or the centering element cannot be fixed here in a set position inside the device, but can vary its position according to contact with the melt front, for example. This approach was not taken into account in the original idea according to the previous examples of FIGS. 1 to 10. However, following preliminary investigations this expansion of the known lance centering represents a highly promising route, which has so far yielded injection patterns that have a significantly increased concentricity by comparison with the conventional method.

The centering element can specifically be adapted to come into contact with the moulding compound, in particular with a melt front formed by the moulding compound. The centering element can be suitably positioned and/or dimensioned for this. For example, the centering element can extend by a predetermined degree into the cavity and/or be positioned at a suitable distance from the gate point, so that it can come into contact with the moulding compound. The coming into contact can take place in the context of a normal forming process and under normal injection pressures.

The device can generally be operable so that the moulding compound exerts a force on the centering element, in particular in the form of a pressure. The force can be a predetermined force, which can be set, for example, by means of the selected injection pressure. The force or the pressure exerted by the moulding compound can act in a direction that pushes the centering element away from the gate point and/or pushes it out of the cavity. It can thus generally be provided that the moulding compound is contact with the centering element for the most part or substantially permanently during the forming process and thereby exerts a predetermined force on it.

In another variant, it can be provided that a position of the centering element inside the device is dynamically variable, in particular according to a variation in the flow velocity of the moulding compound. The position can be a position of the centering element along a longitudinal axis of the cavity, a component longitudinal axis and/or the centering axis. In other words, the centering element can be moved dynamically during the supply of moulding compound, in particular inside the cavity and/or along the previously mentioned longitudinal axes.

The flow velocity of the moulding compound can vary in particular according to the cross-sectional dimensions of the cavity (or any changes in this). For example, the flow velocity of the moulding compound can slow down if the cross section of the cavity widens, or increase if the cavity narrows. A change in the flow velocity can accordingly have an effect on a force exerted on the centering element and/or a pressure exerted on this, wherein a deceleration can be accompanied by a lower force/pressure and an acceleration by a correspondingly increased force/pressure. More importantly, the centering element can be moved dynamically inside the cavity according to a change in the flow velocity (and/or the cross-sectional dimensions of the cavity). This makes it possible for the centering element to be kept constantly in contact with the moulding compound.

According to a further development, the centering element is supported in the device in such a way that the force exerted thereon by the moulding compound can at least partly be compensated for and/or that the centering element is guided steadily onto the melt front formed by the moulding compound. For example, the centering element can be articulated and/or coupled flexibly to the device, wherein the force exerted on the centering element by way of the joint and/or the flexible coupling can at least be partly compensated for or, expressed another way, can be at least partly taken up. The flexible coupling can take place by means of a pretensioning apparatus explained below. Such a flexible or articulated support of the centering element can have the effect that this can change its position and/or orientation under the influence of the moulding compound without losing contact with it and in particular with its melt front, however.

According to a further development, the device is adapted to measure a force exerted on the centering element and, optionally, to vary a counterforce applied to the centering element and in particular to adjust it. The measured force can be a force exerted by the moulding compound and/or a pressure exerted by it, wherein this force and/or pressure can push the centering element in a direction directed away from the gate point. The force can be measured by a suitable measuring or sensor device. The counterforce can be varied according to the measured force. The adjustment can be made according to the measured force, in particular in such a way that the counterforce is varied in the same manner as the force exerted (in particular, increased or reduced in the same manner). To apply a corresponding counter-force, the device can comprise a suitable actuator (for example, an electromotive drive), a driven axle or one of the variants explained below.

The counterforce generated can generally be varied according to a degree of forming of the component or filling level of the cavity and/or according to a time or intermediate stage of the forming process. Thus, for example, the counterforce can be selected to be different at the start and at the end of the injection cycle and generally be increased at the end to generate a certain holding pressure force. In addition or alternatively, an at least temporary increase in the counterforce can be provided at any time to temporarily increase the pressure acting in the cavity, for example if a cavity section with comparatively large cross-sectional dimensions is passed through and/or generally to provide an increased holding pressure.

The device can comprise a load cell to measure the force exerted on the centering element. The load cell can be coupled to the centering element, for example so that an input element or measuring element is displaced according to a displacement of the centering element. This displacement can be registered and evaluated as the result of a force acting on the centering element.

The device can comprise a linear drive and/or a spindle drive for applying the counterforce to the centering element. Such actuators can generally be adapted to push the centering element against the moulding compound and/or in the direction of the gate point and/or contrary to a flow direction of the moulding compound from gate point to centering element. The activation of the actuators can take place in a controlled manner and in particular according to a force measurement explained above. The counterforce can generally be generated so that a predetermined counterforce value is achieved or not fallen below and/or not exceeded. Alternatively or in addition, the counterforce can be generated so that the centering element assumes or maintains a predetermined position and/or remains in a predetermined position range.

In particular, the device can be adapted to hold the centering element at least temporarily in a substantially constant position during a continuous supply of moulding compound, for example to generate a defined holding pressure. This can take place in spite of floating and/or not positionally fixed support of the centering element inside the device by way of adjustment of the previously explained counterforce, for example.

According to a further development, the device comprises a counterpressure arrangement, which is adapted to exert a compressive force acting contrary to the moulding compound on the centering element and/or to hold the centering element in contact with the moulding compound. The counterpressure arrangement can comprise any of the actuators explained above for generating a counterforce or a counterpressure. Alternatively or in addition, the counterpressure arrangement can comprise a pretensioning apparatus, for example in the form of an elastically deformable spring. In particular, the counterpressure arrangement can be adapted to produce a controlled compressive force or counterforce, for example according to a force exerted by the moulding compound and/or a possible position change of the centering element.

The centering element can be positioned and/or the moulding compound can be capable of supply via the gate point in such a way that the moulding compound is supported by a predetermined force on the centering element. For example, the centering element can extend to a predetermined degree into the cavity and/or be positioned relative to the gate point by analogy with previous explanations in order to achieve suitable support. In addition or alternatively, the injection pressure of the moulding compound can be suitably selected to produce the predetermined support force.

In a further development, the position and/or orientation of the centering element is variable under the effect of a force of the moulding compound. In particular, the centering element can be movable under the influence of a force of the moulding compound, for example along one of the longitudinal axes explained above.

The device can generally comprise a pretensioning apparatus, which pretensions the centering element against the moulding compound and/or in the direction of the gate point. If the centering element is moved under the influence of a force applied by the moulding compound, a corresponding counterforce or a counterpressure can be generated by means of the pretensioning apparatus, in particular so that the centering element is kept in preferably constant contact with the moulding compound. In one variant the pretensioning apparatus comprises at least one elastically deformable element, for example a spring. The elastically deformable element can be deformed according to a displacement of the centering element and provide suitable counter-forces, wherein these are preferably counterforces that vary proportionally to the displacement.

A method for moulding an elongate component can be provided as another aspect, which method is based on the method principle explained above. In addition, the moulding compound can be supplied in the context of this method in such a way that it comes into contact with the centering element and in particular exerts a predetermined force on it.

The method can also comprise any other step or any other feature, in order to provide all of the above or below interactions, operating modes or effects. In particular, the method can comprise a step of measuring a force exerted by the moulding compound on the centering element and/or adjustment of a counterforce applied to the centering element. The method can likewise comprise a step of temporary holding of the centering element in a predetermined position, in order to generate a holding pressure.

### Floating Support Using the Example of FIGS. 11 to 16

Embodiments according to the other aspects are discussed below with reference to FIGS. 11 to 16. Features that coincide in their type or function with the embodiments of FIGS. 1-10 can be provided here with the same reference signs.

FIG. 11 shows a detailed view of a device 10, which is configured in principle by analogy with the embodiment according to FIGS. 1 and 2 and is operated by analogy with this, with the exception of the support of the centering element 34 in the form of a suitable (centering) lance as explained below. All of the following FIGS. 11, 13a, 14, 15 and 16 show variants in which the device 10 is basically oriented vertically and the axes K, R, Z, E explained above likewise run vertically. It is also provided, however, to select other axis alignments, in particular a horizontal progression as shown in FIGS. 1 and 2.

FIG. 11 specifically shows a state in which a moulding compound 21 has already been supplied via a gate point 18 and already surrounds an elongate component 44 in sections. A flow direction of the moulding compound 21 from the gate point 18 in the direction of the centering element (or the lance) 34 is indicated by an arrow 104. It is recognised that the moulding compound 21 rests on a front face of the centering element 34 facing the gate point 18 and is in contact with this. A force likewise acting in the direction of the arrow 104 is accordingly exerted on the centering element 34, so that this is pushed away from the gate point 18 and in the direction of the arrow 106. The lance 34 is not supported fixedly inside the device 10 here, but is received floating in the cavity 28, so to speak. It can consequently change its position (for example, along one of the axes K, R, Z, E) according to the force exerted on it by the moulding compound 21.

Expressed another way and as explained in greater detail below, the lance 34 can be pushed forwards and backwards inside the cavity 28 according to an interaction with the moulding compound 21 and can thus be held constantly in contact with the melt front 100. This also means that the elongate component 44 is always surrounded by moulding compound 21 when it emerges from the centering element 34 into the cavity 28. Figuratively speaking this prevents the elongate component 44 from being exposed in sections or sagging, as it were. Instead it is always directly supported by the moulding compound 21. Overall a higher centering quality is thus achieved, as the elongate component 44 can always be received centrally within the moulding compound 21 and/or extends substantially concentrically along the axes K, R, Z, E.

As is evident in illustration 1 (or FIG. 11), the lance 34 can thus be positioned floating on the melt front 100 in the cavity 28, wherein the term “floating” relates in particular to the possibility explained above of changing the position of the lance 34 according to the force applied by the moulding compound.

Another advantage of this variant is made clear from the following consideration: since the speed of the melt front 100 in the cavity 28 is directly dependent on which volume flow [cm³/s] encounters the free volume [cm³] in the area of the melt front, it quickly becomes clear that extreme jumps in the velocity of the melt front 100 can occur here. At the transition from large contours (sockets or similar) to small contours (round contour of the cable) (i.e. at reductions in the cross section of the cavity 28) in particular, the melt front 100 experiences extreme acceleration. The melt front 100 thus flows at an increased velocity and/or force in the direction of the lance 34 and pushes this out of the cavity 28. Caused by the inertia of the slide carriage (approx. 950 kg), this cannot be accelerated fast enough to maintain a defined distance between melt front 100 and lance tip. Conversely, on the transition from small contours to large contours (i.e. at enlargements of the cross section of the cavity 28), an extreme deceleration of the melt front takes place, which likewise cannot be compensated for by the dynamic possibilities of the slide carriage or the injection pressure controller of the injection unit. (Illustration 2 or FIG. 12).

This is also made clear from FIG. 12, in which an example of a cavity 28 with variable cross-sectional dimensions is shown. Furthermore, FIG. 12 also contains a velocity-path diagram (v-s), which shows the flow velocity of the moulding compound 21 present in the corresponding areas of the cavity 28. Viewed from left to right, the moulding compound 21 first passes via a comparatively narrow cross-sectional area of the cavity 28 into a significantly widened area 108, which can also be described as a socket. The flow velocity slows there proportionally to the cross section widening. Due to a conical narrowing of the area 108 the flow velocity then increases again accordingly. Then it flows at a constant velocity in the direction of another widened area 110, at which a drop in flow velocity again takes place.

The force with which the moulding compound 21 presses against the lance 34 also decreases or increases with the changing flow velocity. However, since the lance 34 is supported in a floating manner, it can move forwards or backwards accordingly inside the cavity 28 without losing contact with the moulding compound 21. The elongate component 44 is thus always surrounded by moulding compound 21 when exiting from the lance 34, due to which the improvements explained above in respect of the centering are achieved.

With the floating support of the centering lance 34, the lance 34 can be pressed out of the cavity 28 due to the specific mould inner pressure/injection pressure. Since without guidance at its end (i.e. without support or guidance at its end facing away from the melt front 100) the lance would be shot—similar to a projectile—out of the cavity 28, it must be guided in a defined manner. At a specific injection pressure of 250-350 bar and with a lance front face 112 of 11.33 mm² (excluding braid 44, see FIG. 13b), a force of 283.3 N (250 bar) or 396.7 N (350 bar) acts on the lance 34 (illustration 3 or FIG. 13a, b). These values can be calculated in advance by analogy with the mould lifting force, as the calculation process is identical.

If the lance 34 is thus supported in a floating manner and the support can compensate by means of a pretensioning apparatus 114, comprising springs 116 or similar, for the force acting due to the injection pressure, this (i.e. the lance 34) can be carried constantly on the melt front 100. This applies regardless of whether the melt front 100 is fast or slow due to volume jumps in the contour. The lance 34 is thus no longer fixed in relation to the slide carriage, as described in the original aspects, but is adapted dynamically to the melt front 100 and is “pushed ahead” on this. A suitable device 10, for example, is depicted schematically in illustration 4 (or FIG. 14).

More precisely, FIG. 14 again shows a view by analogy with FIG. 11 in its lower region, in which an elongate component 44 is received in a cavity 28 and is moulded into a moulding compound 21 supplied via a gate point 18. The moulding compound 21 here rests in the manner explained above with its melt front 100 on the lance-shaped centering element 34. The latter is thereupon pushed away from the gate point 18 according to the arrow 106.

At its end facing away from the gate point 18, the centering element 34 is coupled to a pretensioning apparatus 114. This functions as a counterpressure device, which applies a force directed opposite to the arrow 106 to the lance 34. This force can be 283.3 N, for example. More precisely, the pretensioning apparatus 114 comprises an elastically deformable element in the form of a spring 116. This is supported on a curved element 118 and is compressed or expanded according to its displacement. A displacement of the curved element 118 in the event of an increasing force applied by the moulding compound 21 is indicated by a dotted and dashed line in FIG. 14. A corresponding displacement path of the centering lance 34 is marked by a double arrow 120.

If the lance 34 is displaced upwards in the manner shown in FIG. 14, the spring 116 is compressed and the force directed opposite to the moulding compound 21 (i.e. the counterforce or the counterpressure) rises proportionally to the displacement path. The lance 34 can thus yield to an increasing injection pressure without losing contact with the melt front 100, however. The component 44 is thus centred especially precisely within the moulding compound 21.

On the other hand, if the injection pressure or the force applied by the moulding compound 21 decreases, the spring 116 relaxes and pushes the centering lance 34 in FIG. 14 downwards. The lance 34 can be held in contact with melt front 100 in this way even when the flow velocity is decreasing, for example, in order to guarantee a precise centering of the component 44. To improve the guiding accuracy, the device 10 in the variant in FIG. 14 also comprises a guide arrangement 122, comprising a rod-shaped lance holder 124 guided in the device 10. This is coupled to a guide plate 126, which comprises a bore 128, which rests on an outer circumference of the lance 34 and guides this.

An additional detailed view in perspective of selected components of the device 10 from FIG. 14 is shown in FIG. 15. It is recognised that the curved element 118 comprises two single curved sections 130, 132, which take up the lance 34 between them and are coupled to this by projections 134. The curved element also comprises a cross member 136 connecting the sections 130, 132 for coupling to the spring 116. Furthermore, the guide plate 126 and its bore 128 are again recognised.

The above variant according to FIGS. 14 and 15 can be described as an elastic, mechanical and/or passive supporting and holding of the lance 34 in contact with the melt front 100. Contrary to the following embodiment according to FIG. 16, no driven actuator is namely provided here, but only a passively deformable spring 116 (i.e. a spring 116 deformable under the influence of external forces and without its own drive).

### Dynamic Pressure-Controlled Support According to FIG. 16

Another implementation option is to equip the centering lance 34 with a load cell 138 at its end (facing away from the gate point 18), for example, and thus to measure the force acting on the lance 34 and thus determine the mould inner pressure at the lance tip. This value can be transmitted via evaluation logic to a small motor controller (neither of these shown), which can adjust the lance 34 dynamically by an actuator in the form of a linear drive 140. In this case the linear drive 140 in the variant from FIG. 16 comprises an electric motor 142, which rotates a spindle 144. The latter is taken up in a threaded hole 146 of a guide plate 126 coupled to the lance 34, the displacement of which plate is guided in turn by linear guides 148. According to a rotation of the spindle 144, the guide plate 126 and the lance 34 coupled thereto (indirectly via the load cell 138) is moved up and down according to the arrows in FIG. 16.

The advantage of this solution compared with the elastically supported “floating lance” from FIGS. 14/15 is a freely adjustable counterpressure of the lance 34 as compared to the melt front 100 over the entire length of the cavity 28. Thus at the start of the injection cycle, for example, a counterpressure of 250 bar (melt front 100→lance tip) and at critical points a higher counterpressure of e.g. 350 bar can be set, in order to realise an extended holding pressure time at this point or to mould undercuts better. The lance 34 can dwell for this at a predetermined point and be held there, although moulding compound 21 continues to be supplied. A schematic diagram of the construction is depicted in illustration 5 (or FIG. 16).

Fundamentally the core of the other aspects of the invention described above is not the schematic configuration of the lance adjustment, but the idea of holding this by means of pressure control and/or by means of spring tension in direct contact with the melt and thus centering the cable (or the component 44) better. A positive side effect is that due to the dwelling of the lance 34 at one point, a brief holding pressure can be generated for previous components in the cavity.

Advantages of the Invention, in Particular in Relation to the Other Aspects Described Above:

Better centering of the cable (or of the component 44) in the injection moulding part by direct contact of the centering lance 34 with the melt front 100.

1-15. (canceled)

16. A device for moulding an elongate component, comprising:
a moulding arrangement, comprising at least one gate point; and
a mould insert, which can be received in the moulding arrangement and displaced relative to the gate point along a displacement axis, wherein the mould insert at least proportionally delimits a cavity, in which a solidifying moulding compound supplied via the gate point can be received, wherein the device also comprises a centering element, which is adapted to receive an elongate component and guide it along a centering axis into the cavity.

17. The device according to claim 16,
wherein the mould insert is displaceable along the displacement axis in such a way that the cavity is enlarged; and/or
wherein the mould insert is displaceable along the displacement axis in such a way that moulding compound received in the cavity flows from the gate point predominantly in a first direction, in particular wherein the first direction runs substantially along the displacement axis and/or corresponds to a displacement direction of the mould insert during the supply of moulding compound.

18. The device according to claim 16,
wherein the centering element protrudes into the cavity and/or is connected in a fluid-conducting manner to this; and/or
wherein the centering element is elongated and/or tubular, at least in sections.

19. The device according to claim 16,
wherein the centering axis extends substantially along the displacement axis or coincides with this; and/or
wherein the device comprises an exit area, from which the elongate component can emerge from the device, in particular wherein the exit area lies substantially opposite the centering element; and/or
wherein the centering element is positioned upstream of the gate point, in particular at a distance of up to approx. 1 cm, up to approx. 2 cm, up to approx. 5 cm, or up to approx. 10 cm.

20. The device according to claim 19,
wherein the device also comprises a control unit, which is configured to control the supply of moulding compound via the gate point in such a way that a melt front spreading upstream of the gate point does not contact the centering element or only flows around it in an area of less than approx. 10 cm, less than approx. 5 cm, less than approx. 2 cm or less than approx. 1 cm in length.

21. The device according to claim 16,
wherein the centering element extends, starting out from a position upstream of the gate point at least as far as the gate point, or by up to approx. 1 cm, up to approx. 2 cm or up to approx. 5 cm beyond it; and/or
wherein the centering element comprises a first end area, which is arranged close to the gate point, and wherein the first end area comprises a flexibly deformable material.

22. The device according to claim 16,
wherein the gate point defines a moulding compound supply direction, which runs at an angle different from 0° to the centering axis, and in particular wherein the moulding compound supply direction runs at an angle between approx. 44° and approx. 91° or substantially orthogonally to the centering axis; and/or
wherein the moulding arrangement comprises at least two mould halves, one of which is configured fixedly, and wherein the centering element is coupled to the fixed mould half

23. The device according to claim 16,
wherein the centering element is adapted to come into contact with the moulding compound, in particular with a melt front formed by the moulding compound; and/or
wherein the device is operable in such a way that the moulding compound exerts a force on the centering element, in particular in the form of a pressure.

24. The device according to claim 23,
wherein a position of the centering element inside the device is dynamically variable, in particular according to a variation in the flow velocity of the moulding compound; and/or
wherein the centering element is supported in the device in such a way that the force exerted on it by the moulding compound can be at least partly compensated for and/or the centering element is carried constantly on the melt front formed by the moulding compound.

25. The device according to claim 16,
wherein the device is adapted to measure a force exerted on the centering element and, optionally, to vary and in particular control a counterforce applied to the centering element.

26. The device according to claim 25,
wherein the device comprises a load cell for measuring the force exerted on the centering element; and/or
wherein the device comprises a linear drive and/or a spindle drive for applying the counterforce to the centering element.

27. The device according to claim 16,
wherein the device is adapted to hold the centering element in a substantially constant position, at least temporarily, during a continuing supply of moulding compound; and/or
wherein the device comprises a counterpressure arrangement, which is adapted to exert a compressive force acting opposite to the moulding compound on the centering element and/or to hold the centering element in contact with the moulding compound.

28. The device according to claim 16,
wherein the centering element is positioned in such a way and/or wherein the moulding compound can be supplied via the gate point in such a way that the moulding compound is supported by a predetermined force on the centering element; and/or
wherein a position and/or orientation of the centering element is variable under the influence of a force of the moulding compound; and/or
wherein the centering element is supported floating in the device, in particular in such a way that the centering element is movable under the influence of a force of the moulding compound.

29. A method for moulding an elongate component,
wherein the method can be executed in particular by means of a device according to claim 1, comprising the steps of:
a) guiding of the component into the cavity by means of the centering element;
b) supplying a solidifying moulding compound via a gate point; and
c) movement of a mould insert along a displacement axis;
wherein steps b) and c) are executed at least partly in parallel.

30. The method according to claim 29,
wherein the moulding compound is supplied in such a way that it comes into contact with the centering element and in particular exerts a predetermined force on it.
